(19) United States
(12) Patent Application Publication
(10) Pub. No.: US 2022/0266632 A1
(43) Pub. Date: Aug. 25, 2022

(54) PNEUMATIC TIRE

(71) Applicant: The Yokohama Rubber Co., LTD., Tokyo (JP)

(72) Inventors: Makoto OZAKI, Kanagawa (JP); Shinya HARIKAE, Kanagawa (JP); Hiroki SUGIURA, Kanagawa (JP); Miyuki NAKAJIMA, Kanagawa (JP)

(21) Appl. No.: 17/633,056

(22) PCT Filed: Jul. 31, 2020
(86) PCT No.: PCT/JP2020/029509

§ 371 Date: Feb. 4, 2022

(30) Foreign Application Priority Data
Aug. 8, 2019 (JP) 2019-146322

(51) Int. Cl. B60C 9/20; B60C 9/00; D02G 3/48; C08L 7/00

(52) U.S. Cl. CPC B60C 9/2003; B60C 9/0042; D02G 3/48; C08L 7/00; B60C 2009/2077; B60C 2001/0066

(57) ABSTRACT

Provided is a pneumatic tire. A belt cover layer made of an organic fiber cord spirally wound along the tire circumferential direction is provided on the outer circumferential side of a belt layer in a tread portion, and a polyethylene terephthalate fiber cord of which the elastic modulus under a load of 2.0 cN/dtex at 100° C. is in the range of 3.5 cN/(tex·%) to 5.5 cN/(tex·%) is used as the organic fiber cord. The coating rubber covering the organic fiber cord contains one or more of natural rubber, styrene-butadiene rubber, or butadiene rubber as a rubber component. The coating rubber is formed of a rubber composition in which the content of natural rubber in the rubber component is 50 mass % or more, and 5.0 parts by mass to 9.0 parts by mass of zinc oxide is blended per 100 parts by mass of the rubber component.

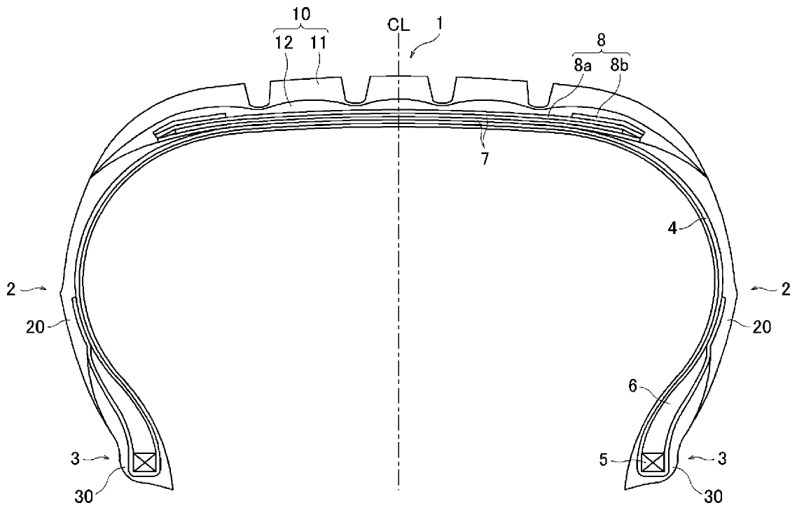

### TECHNICAL FIELD

The present technology relates to a pneumatic tire using polyethylene terephthalate (PET) fiber cords in a belt cover layer.

### BACKGROUND ART

Pneumatic tires for a passenger vehicle or a light truck typically include a structure in which a carcass layer is mounted between a pair of bead portions, a plurality of belt layers are disposed on an outer circumferential side of the carcass layer in a tread portion, and a belt cover layer is disposed on an outer circumferential side of the belt layer, the belt cover layer including a plurality of organic fiber cords spirally wound along a tire circumferential direction. In this structure, the belt cover layer contributes to the improvement of high-speed durability and also contributes to the reduction of mid-range frequency road noise.

In the related art, nylon fiber cords are mainly applied to the organic fiber cords used in the belt cover layer; however, it has been proposed to use polyethylene terephthalate fiber cords (hereinafter referred to as PET fiber cords) that are highly elastic and inexpensive compared to nylon fiber cords (for example, see Japan Unexamined Patent Publication No. 2001-063312). However, the PET fiber cord tends to generate heat more easily than the conventional nylon fiber cord, and in particular, there is a problem that the lower the tension applied to the cord, the easier it is to generate heat. Therefore, there is a need for measures to improve durability at high speeds and under moist heat conditions and reduce road noise while controlling the tension applied to the cord to suppress heat generation.

### SUMMARY

The present technology provides a pneumatic tire having improved durability at high speeds and under moist heat conditions in order to reduce road noise using a PET fiber cord for a belt cover layer.

A pneumatic tire according to the present technology includes: a tread portion extending in a tire circumferential direction and having an annular shape; a pair of sidewall portions respectively disposed on both sides of the tread portion; a pair of bead portions each disposed on an inner side of the pair of sidewall portions in a tire radial direction; a carcass layer mounted between the pair of bead portions; a plurality of belt layers arranged on an outer circumferential side of the carcass layer in the tread portion; and a belt cover layer arranged on an outer circumferential side of the belt layers, the belt cover layer being formed by spirally winding an organic fiber cord covered with coating rubber along the tire circumferential direction, the organic fiber cord being a polyethylene terephthalate fiber cord of which an elastic modulus at a load of 2.0 cN/dtex at 100° C. is in a range of 3.5 cN/(tex·%) to 5.5 cN/(tex·%), the coating rubber containing one or more selected from natural rubber, styrene-butadiene rubber, and butadiene rubber as a rubber component, and the coating rubber being formed of a rubber composition in which a blended amount of natural rubber in the rubber component is 50 mass % or more, and 5.0 parts by mass to 9.0 parts by mass of zinc oxide is blended per 100 parts by mass of the rubber component.

As a result of diligent research on a pneumatic tire equipped with a belt cover layer made of PET fiber cord, the present inventor achieved the present technology by finding that the fatigue resistance and the suppression effect of the cord suitable for the belt cover layer can be obtained by optimizing the dip treatment of PET fiber cord and setting the elastic modulus under a load of 2.0 cN/dtex at 100° C. to be within a predetermined range. That is, in an embodiment of the present technology, a PET fiber cord of which the elastic modulus under the load of 2.0 cN/dtex at 100° C. is in the range of is 3.5 cN/(tex·%) to 5.5 cN/(tex·%) is used as the organic fiber cord constituting the belt cover layer. Thus, the road noise can be effectively reduced while satisfactorily maintaining durability of the pneumatic tire.

Further, coating rubber which contains one or more selected from natural rubber, styrene-butadiene rubber, and butadiene rubber as a rubber component, and which is formed of a rubber composition in which the blended amount of natural rubber in the rubber component is 50 mass % or more, and 5.0 parts by mass to 9.0 parts by mass of zinc oxide is blended per 100 parts by mass of the rubber component, is used as the coating rubber covering the PET fiber cord. Thus, the high-temperature physical properties at break of the coating rubber can be improved by providing the coating rubber with physical properties suitable for combination with the above-described PET fiber cord, and the durability (moist heat durability, high-speed durability) of the tire can be improved.

In an embodiment of the present technology, an in-tire cord tension of the organic fiber cord is preferably 0.9 cN/dtex or more. This is advantageous in suppressing heat generation and improving the durability of the tire.

In an embodiment of the present technology, preferably, the strength at break of the coating rubber at 100° C. is 10.0 MPa or more and the elongation at break of the coating rubber at 100° C. is 280% or more. This is advantageous in improving the durability of the tire.

In an embodiment of the present technology, a storage modulus E1 (100° C.) of the coating rubber measured under conditions of a static strain of 10%, a dynamic strain of ±2%, a frequency of 20 Hz, and a temperature of 100° C. is preferably 3.0 MPa≤E1 (100° C.)≤6.0 MPa. This is advantageous in improving the durability of the tire.

In an embodiment of the present technology, the proportion of free sulfur in the coating rubber is preferably 0.2% or less. This is advantageous in improving the durability of the tire.

### BRIEF DESCRIPTION OF DRAWING

The Drawing is a meridian cross-sectional view illustrating a pneumatic radial tire according to an embodiment of the present technology.

### DETAILED DESCRIPTION

Configurations of embodiments of the present technology will be described in detail below with reference to the accompanying drawings.

As illustrated in the Drawing, a pneumatic tire of an embodiment of the present technology includes a tread portion 1, a pair of sidewall portions 2 respectively disposed on both sides of the tread portion 1, and a pair of bead portions 3 each disposed on an inner side of the sidewall portions 2 in a tire radial direction. Note that “CL” in the Drawing denotes a tire equator. Although not illustrated in the Drawing, as the Drawing is a meridian cross-sectional view, the tread portion 1, the sidewall portions 2, and the bead portions 3 each extend in a tire circumferential direction and have an annular shape. Thus, a toroidal basic structure of the pneumatic tire is configured. Although the description using the Drawing is basically based on the illustrated meridian cross-sectional shape, all of the tire components each extend in the tire circumferential direction and have the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords extending in the tire radial direction are mounted between the pair of left and right bead portions 3. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through the respective sidewall portions 2 to each of the bead portions 3) and a folded back portion (a portion folded back around the bead core 5 of each bead portion 3 and extending toward the respective sidewall portion 2) of the carcass layer 4. For example, polyester cords are preferably used as the reinforcing cords of the carcass layer 4.

On the other hand, a plurality (in the illustrated example, two layers) of belt layers 7 are embedded on an outer circumferential side of the carcass layer 4 in the tread portion 1. The belt layers 7 each include a plurality of reinforcing cords inclining with respect to the tire circumferential direction, and are disposed such that the reinforcing cords of the different layers intersect each other. In these belt layers 7, the inclination angle of the reinforcing cords with respect to the tire circumferential direction is set in a range of, for example, 10° to 40°. For example, steel cords are preferably used as the reinforcing cords of the belt layers 7.

A belt cover layer 8 is provided on an outer circumferential side of the belt layers 7 for the purpose of improving high-speed durability and reducing road noise. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°. In an embodiment of the present technology, the belt cover layer 8 always includes a full cover layer 8a that covers the entire region of the belt layers 7, and can be optionally configured to include a pair of edge cover layers 8b that locally cover both end portions of the belt layers 7 (in the illustrated example, including both the full cover layer 8a and the edge cover layers 8b). The belt cover layer 8 is preferably configured such that a strip material made of at least a single organic fiber cord bunched and covered with coating rubber is wound spirally in the tire circumferential direction, and desirably has, in particular, a jointless structure.

In an embodiment of the present technology, as the organic fiber cord constituting the belt cover layer 8, a polyethylene terephthalate fiber cord (PET fiber cord) in which the elastic modulus under a load of 2.0 cN/dtex at 100° C. is in the range of 3.5 cN/(tex·%) to 5.5 cN/(tex·%) is used. By using a specific PET fiber cord as the organic fiber cord constituting the belt cover layer 8 in this way, it is possible to effectively reduce road noise while satisfactorily maintaining durability of the pneumatic tire. When the elastic modulus of this PET fiber cord under a load of 2.0 cN/dtex at 100° C. is less than 3.5 cN/(tex·%), the mid-range frequency road noise cannot be sufficiently reduced. When the elastic modulus of the PET fiber cord under a load of 2.0 cN/dtex at 100° C. exceeds 5.5 cN/(tex·%), the fatigue resistance of the cord decreases and the durability of the tire decreases. In an embodiment of the present technology, the elastic modulus [cN/(tex·%)] under a load of 2.0 cN/dtex at 100° C. is calculated by conducting a tensile test under the conditions of a grip interval of 250 mm and a tensile speed of 300±20 mm/min in accordance with the “Test methods for chemical fibre tire cords” of JIS-L1017, and converting the inclination of the tangent line at the point corresponding to the load 2.0 cN/dtex of the load-elongation curve into the value per tex.

When this organic fiber cord (PET fiber cord) is used as the belt cover layer 8, the in-tire cord tension may be preferably 0.9 cN/dtex or more, more preferably 1.5 cN/dtex to 2.0 cN/dtex. By setting the in-tire cord tension in this way, heat generation can be suppressed and tire durability can be improved. When the in-tire cord tension of this organic fiber cord (PET fiber cord) is less than 0.9 cN/dtex, the peak of tan δ rises, and the effect of improving the durability of the tire cannot be sufficiently obtained. The in-tire cord tension of the organic fiber cord (PET fiber cord) constituting the belt cover layer 8 is measured at two turns or more on the inner side in the tire width direction from the terminal of the strip material constituting the belt cover layer.

In a case where PET fiber cords are used as the organic fiber cords constituting the belt cover layer 8, the PET fiber cords preferably have a heat shrinkage stress of 0.6 cN/tex or more at 100° C. The heat shrinkage stress at 100° C. is set as just described, and thus road noise can be effectively reduced while durability of the pneumatic radial tire is maintained more effectively and successfully. When the heat shrinkage stress of the PET fiber cords at 100° C. is less than 0.6 cN/tex, the suppression effect when traveling cannot be sufficiently improved, and it is difficult to sufficiently maintain high-speed durability. The upper limit value of the heat shrinkage stress of the PET fiber cords at 100° C. is not particularly limited, but is preferably, for example, 2.0 cN/tex. Note that in an embodiment of the present technology, the heat shrinkage stress (cN/tex) at 100° C. is heat shrinkage stress of a sample cord, which is measured in accordance with “Test methods for chemical fibre tire cords” of JIS-L1017 and when heated under the conditions of the sample length of 500 mm and the heating condition at 100° C. for 5 minutes.

In order to obtain the PET fiber cords having the aforementioned physical properties, for example, it is preferable to optimize dip treatment. In other words, before a calendering process, dip treatment with adhesive is performed on the PET fiber cords; however, in a normalizing process after a two-bath treatment, it is preferable that an ambient temperature be set within the range of 210° C. to 250° C. and cord tension be set in the range of 2.2×10⁻² N/tex to 6.7×10⁻² N/tex. Accordingly, desired physical properties described above can be imparted to the PET fiber cords. When the cord tension in the normalizing process is smaller than 2.2×10⁻² N/tex, cord elastic modulus is low, and thus the mid-range frequency road noise cannot be sufficiently reduced. In contrast, when the cord tension is greater than 6.7×10⁻² N/tex, cord elastic modulus is high, and thus fatigue resistance of the cords decreases.

In the tread portion 1, a tread rubber layer 10 is disposed on the outer circumferential side of the above-mentioned tire constituent members (the carcass layer 4, the belt layer 7, and the belt cover layer 8). In particular, in an embodiment of the present technology, the tread rubber layer 10 has a structure in which two types of rubber layers having different physical properties (a cap tread layer 11 and an undertread layer 12) are layered in the tire radial direction. A side rubber layer 20 is disposed on the outer circumferential side (the outer side in the tire width direction) of the carcass layer 4 in the sidewall portion 2, and a rim cushion rubber layer 30 is disposed on the outer circumferential side (the outer side in the tire width direction) of the carcass layer 4 in the bead portion 3.

The organic fiber cord (PET fiber cord) constituting the belt cover layer 8 is covered with coating rubber (hereinafter referred to as belt cover coating rubber). The rubber composition constituting the belt cover coating rubber always contains natural rubber as a rubber component, and styrene-butadiene rubber and/or butadiene rubber can be optionally used in combination. The natural rubber is contained in the rubber component in an amount of 50 mass % or more, preferably 60 mass % or more. In particular, it is preferable to use two types of natural rubber and styrene-butadiene rubber together, or three types of natural rubber, styrene-butadiene rubber, and butadiene rubber. In the former case, the blended amount of natural rubber may be 60 mass % to 80 mass %, and the blended amount of styrene-butadiene rubber may be 20 mass % to 40 mass %. In the latter case, the blended amount of natural rubber may be 50 mass % to 70 mass %, the blended amount of styrene-butadiene rubber may be mass % to 40 mass %, and the blended amount of butadiene rubber may be 5 mass % to 20 mass %. In any case, if the blended amount of the natural rubber is less than 50 mass %, the desired effect of the present technology cannot be sufficiently obtained. As the natural rubber, styrene-butadiene rubber, and butadiene rubber, those usually used for pneumatic tires (particularly, the belt cover coating rubber) can be used.

In an embodiment of the present technology, zinc oxide are always blended in the rubber composition constituting the belt cover coating rubber. The blended amount of zinc oxide is 5.0 parts by mass to 9.0 parts by mass, preferably 6.5 parts by mass to 8.5 parts by mass per 100 parts by mass of the rubber component. By blending zinc oxide in this way, the physical properties of the belt cover coating rubber are improved, which is advantageous in improving the durability of the tire. If the blended amount of zinc oxide is less than 5.0 parts by mass, it becomes difficult to sufficiently secure the hardness of the belt cover coating rubber. If the blended amount of zinc oxide exceeds 9.0 parts by mass, the fatigue resistance may decrease.

In an embodiment of the present technology, carbon black can be further blended into the rubber composition constituting the belt cover coating rubber. The blended amount of carbon black is preferably 35 parts by mass to 65 parts by mass, and more preferably 40 parts by mass to 60 parts by mass per 100 parts by mass of the rubber component. By blending carbon black in this way, hardness and strength can be increased, and it becomes possible to suitably use it for belt cover coating rubber. If the blended amount of carbon black is less than 35 parts by mass, it becomes difficult to sufficiently secure the hardness and strength of the belt cover coating rubber. If the blended amount of carbon black exceeds 65 parts by mass, the rolling resistance may deteriorate.

When carbon black is blended as described above, the nitrogen adsorption specific surface area N₂SA of carbon black is preferably 35 m²/g to 120 m²/g, and more preferably 40 m²/g to 90 m²/g. By using the specific carbon black in this way, the hardness and strength of the belt cover coating rubber can be appropriately increased. If the nitrogen adsorption specific surface area N₂SA of carbon black is less than 35 m²/g, it becomes difficult to sufficiently secure the hardness and strength of the belt cover coating rubber. If the nitrogen adsorption specific surface area N₂SA of carbon black exceeds 120 m²/g, the rolling resistance may deteriorate. In an embodiment of the present technology, the nitrogen adsorption specific surface area N₂SA of carbon black is measured in accordance with JIS (Japanese Industrial Standard) K6217-7.

In an embodiment of the present technology, sulfur can be further blended into the rubber composition constituting the belt cover coating rubber. The blended amount of sulfur is preferably 2.0 parts by mass to 3.5 parts by mass, and more preferably 2.3 parts by mass to 3.2 parts by mass with respect to 100 parts by mass of the rubber component. By blending sulfur in this way, the hardness of the belt cover coating rubber can be appropriately increased. If the blended amount of sulfur is less than 2.0 parts by mass, it becomes difficult to sufficiently secure the hardness of the belt cover coating rubber. If the blended amount of sulfur exceeds 3.5 parts by mass, the elongation of the belt cover coating rubber may decrease.

In an embodiment of the present technology, a vulcanization accelerator can be further blended into the rubber composition constituting the belt cover coating rubber. The blended amount of the vulcanization accelerator is preferably 0.5 parts by mass to 2.0 parts by mass, and more preferably 0.7 parts by mass to 1.5 parts by mass per 100 parts by mass of the rubber component. By blending the vulcanization accelerator in this way, the hardness of the belt cover coating rubber can be appropriately increased. If the blended amount of the vulcanization accelerator is less than 0.5 parts by mass, it becomes difficult to sufficiently secure the hardness of the belt cover coating rubber. If the blended amount of the vulcanization accelerator exceeds 2.0 parts by mass, the elongation of the belt cover coating rubber may decrease.

The belt cover coating rubber has the above-mentioned composition, and the strength at break at 100° C. may be preferably 10.0 MPa or more, more preferably 11 MPa or more, still more preferably 12 MPa or more. The elongation at break of the belt cover coating rubber at 100° C. may be preferably 280% or more, more preferably 300% or more, still more preferably 330% or more. In addition to this, the modulus at 100% elongation (M100) may be preferably 1.5 MPa to 3.5 MPa, more preferably 1.8 MPa to 3.2 MPa. By setting the physical properties in this way, the belt cover coating rubber has a physical property suitable for use in combination with the above-mentioned organic fiber cord (PET fiber cord), which is advantageous in improving the durability of the tire. If the strength at break is less than 10.0 MPa, it becomes difficult to sufficiently secure the durability. If the elongation at break is less than 280%, it becomes difficult to sufficiently secure the durability. If the modulus at 100% elongation (M100) is less than 1.5 MPa, the steering stability decreases. If the modulus at 100% elongation (M100) exceeds 3.5 MPa, the adhesiveness may decrease and the high-speed durability may deteriorate. In an embodiment of the present technology, the strength at break, elongation at break, and modulus at 100% elongation (M100) are measured using a No. 3 dumbbell under the conditions of a tensile speed of 500 mm/min and a temperature of 100° C. in accordance with JIS K6251.

The range of a storage modulus E1 (100° C.) of the belt cover coating rubber measured under the conditions of a static strain of 10%, a dynamic strain of ±2%, a frequency of 20 Hz, and a temperature of 100° C. in accordance with JIS K6394: 2007 may be preferably 3.0 MPa or more and 6.0 MPa or less, and more preferably 3.5 MPa to 5.5 MPa. By setting the storage modulus in this way, high-speed durability can be improved. If the storage modulus E1 (100° C.) deviates from the above-mentioned range, it becomes difficult to satisfactorily exhibit high-speed durability.

In an embodiment of the present technology, the elastic modulus is set for each of the organic fiber cord (PET fiber cord) and the belt cover coating rubber constituting the belt cover layer 8 as described above. However, when the elastic modulus (elastic modulus at a load of 2.0 cN/dtex at 100° C.) of the organic fiber cord (PET fiber cord) constituting the belt cover layer 8 is A, and the elastic modulus (the storage modulus E1 (100° C.) measured under the conditions of a static strain of 10%, a dynamic strain of ±2%, a frequency of 20 Hz, a temperature of 100° C.) of the belt cover coating rubber is B, the ratio A/B may be preferably 0.6 to 1.6, and more preferably 0.7 to 1.5. By setting the relationship of the elastic modulus in this way, high-speed durability can be effectively improved. If the ratio A/B deviates from the above-mentioned range, it becomes difficult to satisfactorily exhibit high-speed durability.

In the vulcanized belt cover coating rubber, the proportion of free sulfur (sulfur atom remaining in a free state without participating in crosslinking after vulcanization) in the rubber may be preferably 0.2% or less, more preferably 0.15% or less, and still more preferably 0.08% or less. By keeping the proportion of free sulfur low in this way, high-speed durability can be effectively improved. If the proportion of free sulfur exceeds 0.2%, the effect of improving high-speed durability may not be sufficiently obtained. In an embodiment of the present technology, the proportion of free sulfur is measured in accordance with JIS K6234.

### Examples

Tires of Conventional Example 1, Comparative Examples 1 to 5, and Examples 1 to 13 were manufactured in which the tires have a size of 225/60R18 and have the basic structure illustrated in the Drawing. The elastic modulus [cN/(tex·%)] at a load of 2.0 cN/dtex at 100° C. and the in-tire cord tension [cN/dtex] were set for the organic fiber cord (PET fiber cord) constituting the belt cover layer as shown in Tables 1 and 2, and the blending of the rubber composition constituting the coating rubber, a strength at break TB (100° C.) [MPa] at 100° C., an elongation at break EB (100° C.) [%] at 100° C., the storage modulus E1 (100° C.) [MPa] at 100° C., and the proportion of free sulfur [%] were changed for the coating rubber (belt cover coating rubber) that covers the organic fiber cord (PET fiber cord) as shown in Tables 1 and 2.

In these examples, the belt cover layer has a jointless structure in which a strip formed by bunching one organic fiber cord (PET fiber cord) and covering it with coating rubber is spirally wound in the tire circumferential direction. The cord density in the strip is 50 cords/50 mm. Further, each organic fiber cord (PET fiber cord) has a structure of 1100 dtex/2.

In each example, the elastic modulus [cN/(tex·%)] under a load of 2.0 cN/dtex at 100° C. was calculated by conducting a tensile test under the conditions of a grip interval of 250 mm and a tensile speed of 300±20 mm/min in accordance with the “Test methods for chemical fibre tire cords” of JIS-L1017, and converting the inclination of the tangent line at the point corresponding to the load 2.0 cN/dtex of the load-elongation curve into the value per tex. Further, the in-tire cord tension [cN/dtex] was obtained by removing the tread rubber from the tread portion to expose the belt cover layer, peeling the fiber cord from a predetermined length range of the belt cover layer, measuring the length after collection thereof, and obtaining the amount of contraction with respect to the length before collection. Specifically, the average value of the amount of contraction was obtained for five fiber cords located at the center of the belt layer on the outermost side. Then, the load corresponding to the amount of contraction (%) was obtained from the S-S curve and measured by converting it into the value per dtex.

In each example, the strength at break TB (100° C.) [MPa] of the belt cover coating rubber at 100° C., the elongation at break EB (100° C.) [%] at 100° C., and the storage modulus E1 (100° C.) at 100° C. [MPa] were measured by vulcanizing the rubber composition of each example at 180° C. for 5 minutes using a mold having a predetermined shape to prepare 2 mm-thick sheet-shaped vulcanized rubber test pieces and performing measurement using these pieces by the following methods.

### TB (100° C.) and EB (100° C.)

Using the vulcanized rubber test pieces of each example, dumbbell type JIS No. 3 test pieces were manufactured in accordance with JIS K6251, a tensile test was conducted under the conditions of a tensile speed of 500 mm/min and a temperature of 100° C. using a fully automated tensile testing machine with a thermostatic chamber, Strograph AR-T (available from Toyo Seiki Seisaku-sho, Ltd.), and the stress at break (strength at break TB (100° C.) [MPa] at 100° C.) and elongation (elongation at break EB (100° C.) [%] at 100° C.) were measured.

### E1 (100° C.)

Using the vulcanized rubber test pieces of each example, the storage modulus E1 (100° C.) [MPa] at 100° C. was measured under the conditions of elongation deformation strain 10%±2%, vibration frequency 20 Hz, and temperature 100° C. in accordance with JIS K6394: 2007 using a viscoelastic spectrometer (available from Toyo Seiki Seisaku-sho, Ltd.).

The proportion of free sulfur [%] was measured using the sodium sulfite method described in JIS K6234.

Road noise, moist heat durability, and high-speed durability were evaluated for these test tires by the following evaluation methods, and the results are also shown in Tables 1 and 2.

### Road Noise

Each of the test tires was mounted on a wheel having a rim size of 18×7J, mounted as front and rear wheels of a passenger vehicle (front wheel drive vehicle) having an engine displacement of 2.5 L, and inflated to an air pressure of 230 kPa, and a sound collecting microphone was placed on an inner side of the window of the driver's seat. A sound pressure level at or near the frequency 315 Hz was measured when the vehicle was driven at an average speed of 50 km/h on a test course having an asphalt road surface. The evaluation results were based on Conventional Example as a reference and indicated the amount of change (dB) to the reference.

Moist Heat Durability

Each of the test tires was mounted on a wheel having a rim size of 18×7J, inflated with oxygen to an internal pressure of 230 kPa, and held for 30 days in a chamber maintained at a chamber temperature of 70° C. and a humidity of 95%. The pre-treated test tires in this manner were mounted on a drum testing machine with a drum with a smooth steel surface and a diameter of 1707 mm, and the ambient temperature was controlled to 38±3° C. The speed was increased from 120 km/h in increments of 10 km/h every 24 hours, and the running distance until failure occurred in the tire was measured. The evaluation results are expressed as index values using measurement values of the running distance, with Conventional Example 1 being assigned an index value of 100. Larger index values indicate longer distance traveled until failure occurs, and better moist heat durability.

### High-Speed Durability

Each of the test tires was mounted on a wheel having a rim size of 18×7J, inflated with an air pressure of 230 kPa, mounted on an indoor drum testing machine (drum diameter 1707 mm), and subjected to a high-speed durability test specified in JIS D4230. Subsequently, the speed was increased by 8 km/h every hour, and the distance traveled until failure occurred in the tire was measured. The evaluation results are expressed as index values using measurement values of the running distance, with Conventional Example 1 being assigned an index value of 100. Larger index values indicate longer distance traveled until failure occurs, and better high speed durability.

### Dry Heat Durability

Each of the test tires was mounted on a wheel having a rim size of 18×7J, inflated with an oxygen pressure of 350 kPa, and stored in a Geer oven at a temperature of 80° C. for 5 days. Such dry heat pre-treated tires were inflated with an air pressure of 230 kPa, mounted on an indoor drum testing machine (drum diameter 1707 mm), and subjected to a high-speed durability test specified in JIS D4230. Subsequently, the speed was increased by 8 km/h every hour, and the distance traveled until failure occurred in the tire was measured. The evaluation results are expressed as index values using measurement values of the running distance, with Conventional Example 1 being assigned an index value of 100. Larger index values indicate longer distance traveled until failure occurs, and better dry heat durability.

TABLE 1

| | | | Conventional | Comparative | Comparative |
|---|---|---|---|---|---|
| | | | Example 1 | Example 1 | Example 2 |
| Organic | Elastic modulus | cN/(tex · %) | 2.0 | 5.8 | 3.2 |
| fiber cord | In-tire cord tension | cN/dtex | 0.7 | 0.7 | 0.7 |
| Coating | NR | Parts by mass | 45 | 45 | 45 |
| rubber | SBR | Parts by mass | 55 | 55 | 55 |
| | CB1 | Parts by mass | 40 | 40 | 40 |
| | CB2 | Parts by mass | | | |
| | CB3 | Parts by mass | | | |
| | Aroma oil | Parts by mass | 5 | 5 | 5 |
| | Anti-aging agent | Parts by mass | 0.5 | 0.5 | 0.5 |
| | Stearic acid | Parts by mass | 1.2 | 1.2 | 1.2 |
| | Zinc oxide | Parts by mass | 4.5 | 4.5 | 4.5 |
| | Vulcanization | Parts by mass | 1.2 | 1.2 | 1.2 |
| | accelerator | | | | |
| | Insoluble sulfur | Parts by mass | 2.8 | 2.8 | 2.8 |
| | TB (100° C.) | MPa | 11.2 | 11.2 | 11.2 |
| | EB (100° C.) | % | 350 | 350 | 350 |
| | E1 (100° C.) | MPa | 4.1 | 4.1 | 4.1 |
| | Free sulfur | % | 0.05 | 0.05 | 0.05 |
| Road noise performance | | dB | 0 | −2.8 | −0.5 |
| Moist heat durability | | Index value | 100 | 95 | 90 |
| High-speed durability | | Index value | 100 | 98 | 103 |
| Dry heat durability | | Index value | 100 | 96 | 101 |
| | | | Comparative | Comparative | |
| | | | Example 3 | Example 4 | Example 1 |
| Organic | Elastic modulus | cN/(tex · %) | 4.5 | 4.5 | 3.8 |
| fiber cord | In-tire cord tension | cN/dtex | 0.7 | 0.7 | 0.7 |
| Coating | NR | Parts by mass | 45 | 45 | 70 |
| rubber | SBR | Parts by mass | 55 | 55 | 30 |
| | CB1 | Parts by mass | 40 | 40 | 40 |
| | CB2 | Parts by mass | | | |
| | CB3 | Parts by mass | | | |
| | Aroma oil | Parts by mass | 5 | 5 | 5 |
| | Anti-aging agent | Parts by mass | 0.5 | 0.5 | 0.5 |
| | Stearic acid | Parts by mass | 1.2 | 1.2 | 1.2 |
| | Zinc oxide | Parts by mass | 4.5 | 6.5 | 6.5 |
| | Vulcanization | Parts by mass | 1.2 | 1.2 | 1.2 |
| | accelerator | | | | |
| | Insoluble sulfur | Parts by mass | 2.8 | 2.8 | 2.8 |
| | TB (100° C.) | MPa | 11.2 | 11.2 | 12.8 |
| | EB (100° C.) | % | 350 | 350 | 410 |
| | E1 (100° C.) | MPa | 4.1 | 4.1 | 4.6 |
| | Free sulfur | % | 0.05 | 0.05 | 0.05 |

| | | | | |
|---|---|---|---|---|
| Road noise performance | dB | −1.8 | −1.8 | −1.5 |
| Moist heat durability | Index value | 88 | 90 | 105 |
| High-speed durability | Index value | 103 | 97 | 108 |
| Dry heat durability | Index value | 101 | 103 | 109 |

| | | | Example 2 | Example 3 | Example 4 |
|---|---|---|---|---|---|
| Organic | Elastic modulus | cN/(tex · %) | 4.5 | 5.0 | 5.3 |
| fiber cord | In-tire cord tension | cN/dtex | 0.7 | 0.7 | 0.7 |
| Coating | NR | Parts by mass | 70 | 70 | 70 |
| rubber | SBR | Parts by mass | 30 | 30 | 30 |
| | CB1 | Parts by mass | 40 | 40 | 40 |
| | CB2 | Parts by mass | | | |
| | CB3 | Parts by mass | | | |
| | Aroma oil | Parts by mass | 5 | 5 | 5 |
| | Anti-aging agent | Parts by mass | 0.5 | 0.5 | 0.5 |
| | Stearic acid | Parts by mass | 1.2 | 1.2 | 1.2 |
| | Zinc oxide | Parts by mass | 6.5 | 6.5 | 6.5 |
| | Vulcanization | Parts by mass | 1.2 | 1.2 | 1.2 |
| | accelerator | | | | |
| | Insoluble sulfur | Parts by mass | 2.8 | 2.8 | 2.8 |
| | TB (100° C.) | MPa | 12.8 | 12.8 | 12.8 |
| | EB (100° C.) | % | 410 | 410 | 410 |
| | E1 (100° C.) | MPa | 4.6 | 4.6 | 4.6 |
| | Free sulfur | % | 0.05 | 0.05 | 0.05 |

| | | | | |
|---|---|---|---|---|
| Road noise performance | dB | −1.8 | −2.5 | −2.5 |
| Moist heat durability | Index value | 115 | 112 | 110 |
| High-speed durability | Index value | 110 | 111 | 111 |
| Dry heat durability | Index value | 108 | 108 | 107 |

TABLE 2

| | | | | | Comparative |
|---|---|---|---|---|---|
| | | | Example 5 | Example 6 | Example 5 |
| Organic | Elastic modulus | cN/(tex · %) | 4.5 | 4.5 | 4.5 |
| fiber cord | In-tire cord tension | cN/dtex | 0.7 | 0.7 | 0.7 |
| Coating | NR | Parts by mass | 70 | 70 | 70 |
| rubber | SBR | Parts by mass | 30 | 30 | 30 |
| | CB1 | Parts by mass | 40 | 40 | 40 |
| | CB2 | Parts by mass | | | |
| | CB3 | Parts by mass | | | |
| | Aroma oil | Parts by mass | 5 | 5 | 5 |
| | Anti-aging agent | Parts by mass | 0.5 | 0.5 | 0.5 |
| | Stearic acid | Parts by mass | 1.2 | 1.2 | 1.2 |
| | Zinc oxide | Parts by mass | 7.5 | 8.5 | 9.5 |
| | Vulcanization | Parts by mass | 1.2 | 1.2 | 1.2 |
| | accelerator | | | | |
| | Insoluble sulfur | Parts by mass | 2.8 | 2.8 | 2.8 |
| | TB (100° C.) | MPa | 13 | 12.5 | 12.0 |
| | EB (100° C.) | % | 400 | 380 | 340 |
| | E1 (100° C.) | MPa | 4.5 | 4.3 | 4.1 |
| | Free sulfur | % | 0.05 | 0.05 | 0.05 |

| | | | | |
|---|---|---|---|---|
| Road noise performance | dB | −2.8 | −2.8 | −2.8 |
| Moist heat durability | Index value | 117 | 116 | 97 |
| High-speed durability | Index value | 118 | 115 | 94 |
| Dry heat durability | Index value | 115 | 118 | 99 |

| | | | Example 7 | Example 8 | Example 9 | Example 10 |
|---|---|---|---|---|---|---|
| Organic | Elastic modulus | cN/(tex · %) | 4.5 | 4.5 | 4.5 | 4.5 |
| fiber cord | In-tire cord tension | cN/dtex | 0.7 | 0.7 | 0.7 | 0.7 |
| Coating | NR | Parts by mass | 70 | 80 | 60 | 70 |
| rubber | SBR | Parts by mass | 30 | 20 | 40 | 30 |
| | CB1 | Parts by mass | | 20 | | 45 |
| | CB2 | Parts by mass | 40 | | 40 | |
| | CB3 | Parts by mass | | 20 | | |
| | Aroma oil | Parts by mass | 5 | 5 | 15 | 5 |
| | Anti-aging agent | Parts by mass | 0.5 | 0.5 | 0.5 | 0.5 |
| | Stearic acid | Parts by mass | 1.2 | 1.2 | 1.2 | 1.2 |
| | Zinc oxide | Parts by mass | 7.5 | 7.5 | 7.5 | 7.5 |
| | Vulcanization | Parts by mass | 1.2 | 1.2 | 1.2 | 1.2 |
| | accelerator | | | | | |
| | Insoluble sulfur | Parts by mass | 3.5 | 3.5 | 2.8 | 2.8 |
| | TB (100° C.) | MPa | 9.8 | 13.9 | 9.5 | 12.8 |
| | EB (100° C.) | % | 270 | 420 | 520 | 350 |
| | E1 (100° C.) | MPa | 4.1 | 4.9 | 2.8 | 5.0 |
| | Free sulfur | % | 0.05 | 0.05 | 0.05 | 0.05 |

| | | | | | |
|---|---|---|---|---|---|
| Road noise performance | dB | −2.8 | −2.8 | −2.7 | −2.8 |
| Moist heat durability | Index value | 108 | 119 | 105 | 116 |
| High-speed durability | Index value | 106 | 120 | 106 | 114 |
| Dry heat durability | Index value | 103 | 123 | 105 | 112 |

| | | | Example 11 | Example 12 | Example 13 |
|---|---|---|---|---|---|
| Organic | Elastic modulus | cN/(tex · %) | 4.5 | 4.5 | 4.5 |
| fiber cord | In-tire cord tension | cN/dtex | 0.7 | 0.7 | 0.7 |
| Coating | NR | Parts by mass | 70 | 70 | 70 |
| rubber | SBR | Parts by mass | 30 | 30 | 30 |
| | CB1 | Parts by mass | 50 | 40 | 40 |
| | CB2 | Parts by mass | | | |
| | CB3 | Parts by mass | | | |
| | Aroma oil | Parts by mass | 2 | 5 | 5 |
| | Anti-aging agent | Parts by mass | 0.5 | 0.5 | 0.5 |
| | Stearic acid | Parts by mass | 1.2 | 1.2 | 1.2 |
| | Zinc oxide | Parts by mass | 7.5 | 7.5 | 7.5 |
| | Vulcanization | Parts by mass | 1.2 | 1.0 | 0.6 |
| | accelerator | | | | |
| | Insoluble sulfur | Parts by mass | 2.8 | 2.8 | 2.8 |
| | TB (100° C.) | MPa | 12.8 | 13.0 | 10.9 |
| | EB (100° C.) | % | 290 | 420 | 520 |
| | E1 (100° C.) | MPa | 6.1 | 4.4 | 3.5 |
| | Free sulfur | % | 0.05 | 0.12 | 0.3 |

| | | | | |
|---|---|---|---|---|
| Road noise performance | dB | −2.9 | −2.8 | −2.8 |
| Moist heat durability | Index value | 106 | 117 | 104 |
| High-speed durability | Index value | 106 | 117 | 103 |
| Dry heat durability | Index value | 107 | 116 | 107 |

Types of raw materials used in Tables 1 and 2 are described below.
NR: Natural rubber, STR 20
SBR: Styrene-butadiene rubber, SBR 1502, available from ZEON CORPORATION
CB1: Carbon black (HAF), Show Black N330, available from Cabot Japan K.K.
CB2: Carbon black (GPF), Niteron #NG, available from Nippon Steel Chemical Carbon Co. Ltd.
CB3: Carbon black (ISAF), Show Black N234, available from Cabot Japan K.K.
Aroma oil: Extract No. 4S, available from Showa Shell Sekiyu K.K.

Anti-aging agent: NOCRAC 224, available from Ouchi Shinko Chemical Industrial Co., Ltd.
Stearic acid: Beads Stearic Acid NY, available from Nippon Oil & Fats Co., Ltd.
Zinc oxide: Zinc Oxide III, available from Seido Chemical Industry Co., Ltd.
Vulcanization accelerator: NS-G, available from Sanshin Chemical Industry Co., Ltd.
Insoluble sulfur: MUCRON OT-20 (sulfur content: 80 mass %), available from Shikoku Chemicals Corporation

As can be seen from Tables 1 and 2, in the tires of Examples 1 to 13, the road noise was reduced and the moist heat durability, dry heat durability and high-speed durability were improved as compared with those of Conventional Example 1 as a reference. On the other hand, in the tire of Comparative Example 1, the elastic modulus under a load of 2.0 cN/dtex at 100° C. of the polyethylene terephthalate fiber cord constituting the belt cover layer was high, and the blended amounts of the natural rubber and the zinc oxide in the coating rubber were small. Therefore, the moist heat durability, dry heat durability, and high-speed durability were deteriorated. In the tire of Comparative Example 2, the elastic modulus under a load of 2.0 cN/dtex at 100° C. of the polyethylene terephthalate fiber cord constituting the belt cover layer was low, and the blended amounts of the natural rubber and the zinc oxide in the coating rubber were small. Therefore, the road noise could not be sufficiently reduced, and the moist heat durability was deteriorated. In the tire of Comparative Example 3, the moist heat durability deteriorated since the blended amounts of the natural rubber and the zinc oxide in the coating rubber were small. In the tire of Comparative Example 4, the moist heat durability and the high-speed durability were deteriorated since the blended amount of the natural rubber in the coating rubber was small. In the tire of Comparative Example 5, the moist heat durability and the high-speed durability were deteriorated since the blended amount of the zinc oxide in the coating rubber was large.

1-5. (canceled)

6. A pneumatic tire, comprising:
a tread portion extending in a tire circumferential direction and having an annular shape;
a pair of sidewall portions respectively disposed on both sides of the tread portion;
a pair of bead portions each disposed on an inner side of the pair of sidewall portions in a tire radial direction;
a carcass layer mounted between the pair of bead portions;
a plurality of belt layers arranged on an outer circumferential side of the carcass layer in the tread portion; and
a belt cover layer arranged on an outer circumferential side of the belt layers,
the belt cover layer being formed by spirally winding an organic fiber cord covered with coating rubber along the tire circumferential direction,
the organic fiber cord being a polyethylene terephthalate fiber cord of which an elastic modulus at a load of 2.0 cN/dtex at 100° C. is in a range of 3.5 cN/(tex·%) to 5.5 cN/(tex·%),
the coating rubber containing one or more selected from natural rubber, styrene-butadiene rubber, and butadiene rubber as a rubber component, and
the coating rubber being formed of a rubber composition in which a blended amount of natural rubber in the rubber component is 50 mass % or more, and 5.0 parts by mass to 9.0 parts by mass of zinc oxide is blended per 100 parts by mass of the rubber component.

7. The pneumatic tire according to claim 6, wherein an in-tire cord tension of the organic fiber cord is 0.9 cN/dtex or more.

8. The pneumatic tire according to claim 6, wherein
a strength at break of the coating rubber at 100° C. is 10.0 MPa or more, and
an elongation at break of the coating rubber at 100° C. is 280% or more.

9. The pneumatic tire according to claim 6, wherein a storage modulus E1 (100° C.) of the coating rubber measured under conditions of a static strain of 10%, a dynamic strain of ±2%, a frequency of 20 Hz, and a temperature of 100° C. is 3.0 MPa≤E1 (100° C.) 6.0 MPa.

10. The pneumatic tire according to claim 6, wherein a proportion of free sulfur in the coating rubber is 0.2% or less.

11. The pneumatic tire according to claim 7, wherein
a strength at break of the coating rubber at 100° C. is 10.0 MPa or more, and
an elongation at break of the coating rubber at 100° C. is 280% or more.

12. The pneumatic tire according to claim 11, wherein a storage modulus E1 (100° C.) of the coating rubber measured under conditions of a static strain of 10%, a dynamic strain of ±2%, a frequency of 20 Hz, and a temperature of 100° C. is 3.0 MPa≤E1 (100° C.)≤6.0 MPa.

13. The pneumatic tire according to claim 12, wherein a proportion of free sulfur in the coating rubber is 0.2% or less.
